(19) United States
(12) Patent Application Publication
(10) Pub. No.: US 2025/0035124 A1
(43) Pub. Date: Jan. 30, 2025

(54) IMPELLER, PRESSURIZATION DEVICE, AND GAS WATER HEATER

(71) Applicant: WUHU MIDEA SMART KITCHEN APPLIANCE MANUFACTURING CO., LTD., Wuhu (CN)

(72) Inventor: Bixing Yin, Wuhu (CN)

(21) Appl. No.: 18/911,802

(22) Filed: Oct. 10, 2024

Related U.S. Application Data
(63) Continuation of application No. PCT/CN2023/090312, filed on Apr. 24, 2023.

(30) Foreign Application Priority Data
Dec. 29, 2022 (CN) 202211717712.6

(51) Int. Cl. F04D 29/24; F04D 1/04; F24H 1/10

(52) U.S. Cl. CPC F04D 29/24; F04D 1/04; F24H 1/107

(57) ABSTRACT

An impeller includes a first cover plate having an impeller inlet at a center of the first cover plate, and a second cover plate arranged opposite to the first cover plate. An impeller outlet is formed between an outer circumference of the second cover plate and an outer circumference of the first cover plate. The impeller further includes a first blade disposed between the first cover plate and the second cover plate, and a second blade disposed between the first cover plate and the second cover plate and staggered with the first blade. The first blade and the second blade have different lengths.

### CROSS-REFERENCE TO RELATED APPLICATIONS

This application is a continuation International Application No. PCT/CN2023/090312, filed on Apr. 24, 2023, which claims priority to Chinese patent application No. 202211717712.6 filed on Dec. 29, 2022, the entire contents of both of which are incorporated herein by reference.

### FIELD

The present disclosure relates to the field of pressurization technologies, and more particularly, to an impeller, a pressurization device, and a gas water heater.

### BACKGROUND

With the development of economy, gas water heater has been widely adopted by consumers because of energy efficiency and convenience of the gas water heater. However, residents living on higher floors often experience insufficient water pressure, which can prevent the gas water heater from starting up properly or result in poor user experience. Therefore, there is room for improvement.

### SUMMARY

The present disclosure aims to solve at least one of the technical problems in the related art. To this end, the present disclosure provides an impeller which can be capable of achieving a satisfactory pressurization effect.

The present disclosure further provides a pressurization device and a gas water heater.

According to one embodiment of the present disclosure, an impeller is provided. The impeller includes a first cover plate, a second cover plate, a first blade, and a second blade. The first cover plate has an impeller inlet at a center of the first cover plate. The second cover plate is arranged opposite to the first cover plate. An impeller outlet is formed between an outer circumference of the second cover plate and an outer circumference of the first cover plate. The first blade is disposed between the first cover plate and the second cover plate. The second blade is disposed between the first cover plate and the second cover plate and staggered with the first blade. The first blade and the second blade have different lengths.

With the impeller according to the embodiment of the present disclosure, the impeller inlet is formed at the center of the first cover plate and the impeller outlet is formed between the outer circumferences of the two cover plates, which enables liquid in the impeller to flow with acceleration out of the impeller outlet under an action of a centrifugal force, realizing pressurization of the impeller. Setting a plurality of blades with different lengths can allow a flow-head curve of an entire impeller to be relatively flat, in such a manner that a water pressure decreases gradually with an increase of a flow. Therefore, an efficiency of an entire machine can be effectively improved, enhancing user experience.

According to some embodiments of the present disclosure, in a radial direction of the impeller, the first blade has an outer end extending to an outer circumferential edge of the first cover plate and an inner end extending to an inner side of an inner circumferential edge of the first cover plate.

In some examples, the second blade has two ends disposed between the outer circumferential edge and the inner circumferential edge of the first cover plate.

In some examples, in the radial direction of the impeller, the outer ends of the first blades and outer ends of the second blades are arranged at equal intervals in a circumferential direction of the impeller.

In some examples, an inner end of the second blade is offset with respect to a center of two first blades adjacent to the second blade.

In some examples, four first blades and four second blades are provided. The inner end of the second blade is offset in a direction of rotation with respect to the center of two first blades adjacent to the second blade by an offset angle of a, 8°≤a≤15°.

According to some embodiments of the present disclosure, inner ends of a plurality of first blades are arranged at intervals in a circumferential direction of a first hypothetical circle, the first hypothetical circle having a diameter of D0. Inner ends of a plurality of second blades are arranged at intervals in a circumferential direction of a second hypothetical circle, the second hypothetical circle having a diameter of D1, and the impeller having a diameter of D2, where 0.4D2≤D0≤0.5D2,0.5D2≤D1≤0.6D2.

According to some embodiments of the present disclosure, the first blade and the second blade are each formed in an arc shape.

In some examples, the first blade and the second blade have different curvatures.

According to some embodiments of the present disclosure, the blade has a first protrusion protruding towards the second cover plate. The second cover plate has a blade groove engaged with the blade, a bottom wall of the blade groove having a first slot.

In some examples, the blade is adapted to be inserted into the blade groove, and the first protrusion is inserted into the first slot.

In some examples, the blade and the first cover plate are formed in one piece.

In some examples, the second cover plate is a one piece member.

In some examples, the first protrusion is connected to the second cover plate through thermoplastic process.

In some examples, the second cover plate has a connection part at a center of the second cover plate, at least part of the connection part protruding from a side of the second cover plate towards the first cover plate.

In some examples, a part of the connection part extends into the center of the first cover plate, and the impeller inlet is formed between the part of the connection part and an inner circumferential surface of the first cover plate.

In some examples, an inner end of the first blade is abutted with the connection part.

In some examples, the inner circumferential surface of the first cover plate is a convex arc-shaped surface.

In some examples, an outer circumferential surface of the connection part is a concave arc-shaped surface.

According to one embodiment of the present disclosure, a pressurization device is provided. The pressurization device includes the impeller according to the above-mentioned embodiments. By adopting the impeller, the liquid in the impeller can be accelerated outflow from the impeller outlet under the action of the centrifugal force, realizing pressurization of the pressurization device. In addition, a flow-head curve of the pressurization device can be relatively flat, and the water pressure can be decreased gradually with the increase of the flow. Therefore, the efficiency of the entire machine can be effectively improved, enhancing the user experience.

According to some embodiments of the present disclosure, the pressurization device includes a housing having a water inlet and a water outlet; a plurality of impellers disposed between the water inlet and the water outlet, the plurality of impellers being arranged at intervals in an axial direction of the plurality of impellers; a water guide member disposed between two adjacent impellers of the plurality of impellers, the water guide member being configured to guide water at outlets of upstream impellers of the plurality of impellers to inlets of downstream impellers of the plurality of impellers in a direction of water flow; and a drive member disposed at the housing and engaged with the plurality of impellers to drive the plurality of impellers to rotate.

According to one embodiment of the present disclosure, a gas water heater is provided. The gas water heater includes the pressurization device according to the above-mentioned embodiments. By adopting the pressurization device, pressurization of the gas water heater is realized. In addition, a flow-head curve of the gas water heater can be relatively flat, and the water pressure can be decreased gradually with the increase of the flow. Therefore, the efficiency of the entire machine can be effectively improved, enhancing the user experience.

Additional aspects and advantages of the present disclosure will be provided at least in part in the following description, or will become apparent at least in part from the following description, or can be learned from practicing of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings.

FIG. 1 is a schematic structural view of a pressurization device according to an embodiment of the present disclosure.

FIG. 2 is a cross-sectional view of a pressurization device according to an embodiment of the present disclosure.

FIG. 3 is a schematic structural view of an impeller according to an embodiment of the present disclosure.

FIG. 4 is a schematic structural view of a first cover plate according to an embodiment of the present disclosure.

FIG. 5 is a cross-sectional view of a first cover plate according to an embodiment of the present disclosure.

FIG. 6 is a schematic structural view of a water guide member according to an embodiment of the present disclosure from a perspective.

FIG. 7 is a schematic structural view of a water guide member according to an embodiment of the present disclosure from another perspective.

### REFERENCE NUMERALS OF THE ACCOMPANYING DRAWINGS

pressurization device 100;
housing 10; first casing 11; water inlet 111; second casing 12; water outlet 121;
drive member 20; drive shaft 21;
impeller 30; impeller inlet 301; impeller outlet 302; first cover plate 31; second cover plate 32; blade groove 321; first slot 322; connection part 323; keyway 3231; balancing hole 3232; blade 34; first blade 341; second blade 342; first protrusion 343;
water guide member 40; through hole 401; water guide inlet 402; water guide outlet 403.

### DETAILED DESCRIPTION OF THE EMBODIMENTS

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limiting, the embodiments of the present disclosure.

In the description of the present disclosure, it should be understood that, the orientation or the position indicated by terms such as “center,” “longitudinal,” “lateral,” “length,” “width,” “thickness,” “over,” “below,” “front,” “rear,” “left,” “right,” “vertical,” “horizontal,” “top,” “bottom,” “inner,” “outer,” “clockwise,” “anti-clockwise,” “axial,” “radial,” and “circumferential” should be construed to refer to the orientation or the position as shown in the drawings, and is only for the convenience of describing the present disclosure and simplifying the description, rather than indicating or implying that the pointed device or element must have a specific orientation, or be constructed and operated in a specific orientation, and therefore cannot be understood as a limitation of the present disclosure. In addition, the features associated with “first” and “second” may explicitly or implicitly include one or more of the features. In the description of the present disclosure, unless otherwise specified, “plurality” means two or more.

In the description of the present disclosure, it should be noted that, unless otherwise clearly stipulated and limited, terms such as “mount,” “connect,” and “connect to” should be understood in a broad sense. For example, it may be a fixed connection or a detachable connection or connection as one piece; mechanical connection or electrical connection; direct connection or indirect connection through an intermediate; or internal communication of two components. For those skilled in the art, specific meanings of the above-mentioned terms in the present disclosure can be understood according to specific circumstances.

It was found that a maximum pressure (i.e., a zero flow pressure) of a gas-fired hot water pressurization device 100 in the related art can reach 17 meters, but a flow-head curve is steep, with a water pressure sharply decreasing as a flow increases. Consequently, a mere high maximum pressure is practically meaningless. An efficiency of the pressurization device 100 is generally low, about 15%, which cannot meet a user's needs. For this reason, an impeller 30 is provided, which can effectively solve a problem of a steep flow-head curve and thus the water pressure sharply decreasing as the flow increases.

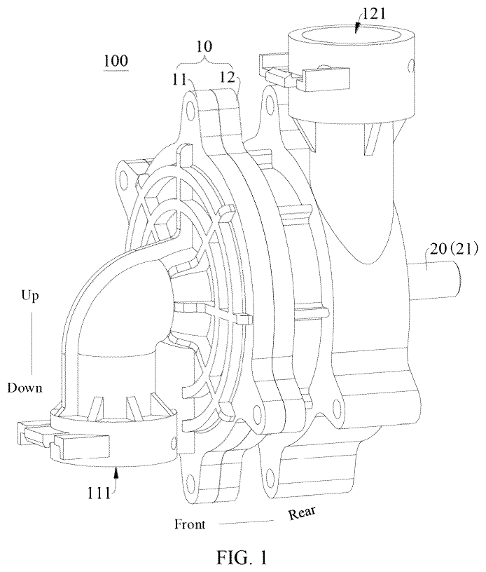

As illustrated in FIG. 1 to FIG. 7, the impeller 30 according to an embodiment of the present disclosure includes a first cover plate 31, a second cover plate 32, a first blade 341, and a second blade 342. The first cover plate 31 has an impeller inlet 301 at a center of the first cover plate 31. The second cover plate 32 is arranged opposite to the first cover plate 31. The first blade 341 is disposed between the first cover plate 31 and the second cover plate 32. The second blade 342 is also disposed between the first cover plate 31 and the second cover plate 32. An impeller outlet 302 is formed between an outer circumference of the second cover plate 32 and an outer circumference of the first cover plate 31. When the impeller 30 rotates, liquid enters the impeller 30 through the impeller inlet 301, and then flows out from the impeller outlet 302, to achieve pressurization of the liquid by the impeller 30.

The first blades 341 are staggered with the second blades 342. That is, one second blade 342 is disposed between two adjacent first blades 341, and one first blade 341 is disposed between two adjacent second blades 342. In addition, the first blade 341 and the second blade 342 have different lengths. That is, lengths of two adjacent blades 34 are different. The two blades 34 with different lengths, cooperating with each other, can allow a flow-head curve of the impeller 30 to be relatively flat. In practice, the water pressure decreases slowly both at a small flow and a large flow, significantly expanding a practical water usage range for the user. In this way, a pressurization efficiency of the impeller 30 is improved, enhancing user experience.

With the impeller 30 according to the embodiment of the present disclosure, by arranging the impeller inlet 301 at the center of the first cover plate 31 and defining the impeller outlet 302 between the outer circumferences of the two cover plates, liquid in the impeller 30 can be accelerated to flow out from the impeller outlet 302 under an action of a centrifugal force, realizing the pressurization of the impeller 30. By arranging a plurality of blades 34 with different lengths, a flow-head curve of an entire impeller 30 can be relatively flat, and the water pressure can be decreased slowly with an increase of the flow. Therefore, an efficiency of the entire machine can be effectively improved, enhancing the user experience.

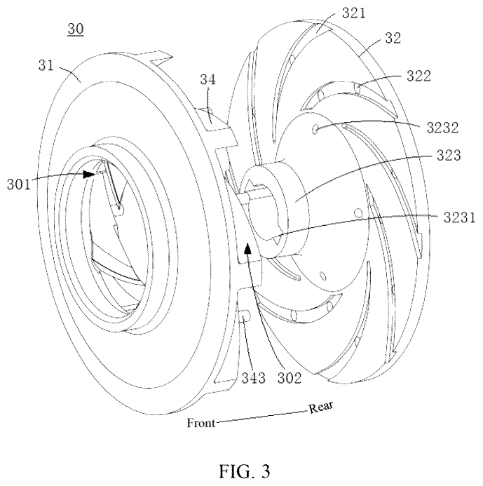

As illustrated in FIG. 3, according to some embodiments of the present disclosure, in a radial direction of the impeller 30, the first blade 341 has an outer end extending to an outer circumferential edge of the first cover plate 31 and an inner end extending to an inner side of an inner circumferential edge of the first cover plate 31. The second blade 342 has two ends disposed between the outer circumferential edge and the inner circumferential edge of the first cover plate 31. That is, a length of the first blade 341 is greater than that of the second blade 342.

In some embodiments, under the condition that a rotational angular velocity of the impeller 30 is constant, a centrifugal force of the blade 34 on the liquid becomes larger in a direction of the impeller 30 from inside to outside. Mutual cooperation between the first blade 341 and the second blade 342 enables the liquid to be pressurized by the first blade 341 to a predetermined speed, and then to be jointly pressurized by the first blade 341 and the second blade 342, reducing an operation pressure of the blade 34 and thus prolonging a service life of the blade 34.

As illustrated in FIG. 3, in some examples, liquid with the small flow can be in direct contact with the inner end of the first blade 341 after passing through the impeller inlet 301. The liquid, guided by the first blade 341 when the impeller 30 rotates, is accelerated to flow out of the impeller outlet 302 in an extension direction of the first blade 341. Liquid with the large flow can be in contact with an inner end of the second blade 342 under an action of inertia of the liquid. In addition, the liquid, guided by the second blade 342 when the impeller 30 rotates, can flow out of the impeller outlet 302 in an extension direction of the second blade 342. Therefore, the impeller 30 can be allowed to achieve a good pressurization effect for liquids with various flows.

In some embodiments, when liquid located at a front side of the impeller 30 is divided into a plurality of regions with liquid having non-uniform flows, the mutual cooperation between the first blade 341 and the second blade 342 can improve stability of pressurizing the liquid by the impeller 30. In this way, turbulent liquid flows out stably after being pressurized by the impeller 30, and thus an pressurization effect of the impeller 30 on the liquid is improved.

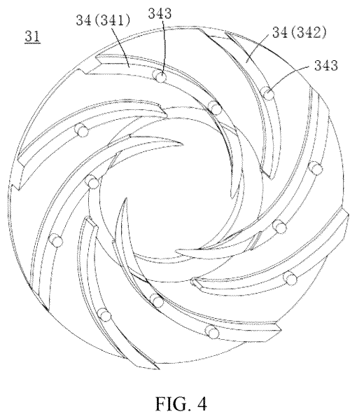

As illustrated in FIG. 4, in some examples, in the radial direction of the impeller 30, outer ends of all blades 34 are arranged at equal intervals in a circumferential direction of the impeller 30. In addition, the first blade 341 is staggered with the second blade 342, which is conducive to maintaining a center of gravity of the impeller 30 coincident with a center of the impeller 30, enabling stable rotation of the impeller 30 and consequently stable pressurization of the liquid. The inner end of the second blade 342 is offset with respect to a center of two first blades 341 adjacent to the second blade 342, which facilitates adjustment of a pressurization and driving effect of the impeller 30 on the liquid with different flows, so as to improve stability of pressurization of the liquid by the impeller 30.

As illustrated in FIG. 4, in some examples, the inner end of the second blade 342 is offset in a direction of rotation with respect to the center of two first blades 341 adjacent to the second blade 342. The impeller 30 is configured to rotate in a counterclockwise direction. The inner end of the second blade 342 is offset in the counterclockwise direction with respect to the first blade 341. Therefore, a guiding effect of the second blade 342 on the liquid can be improved and resistance can be reduced, facilitating improvement of a liquid flow of the impeller 30. Therefore, the pressurization effect of the impeller 30 on the liquid is improved.

As illustrated in FIG. 4, in some examples, a quantity of the first blade 341 is the same as that of the second blade 342, which is conducive to ensuring the stable rotation of the impeller 30. A plurality of the first blades 341 and a plurality of the second blades 342 may be provided. For example, four first blades 341 and four second blades 342 are provided. Mutual cooperation of a plurality of blades 34 can improve the pressurization effect of the impeller 30 on the liquid.

In some examples, an offset angle by which the inner end of the second blade 342 is offset from the center of two first blades 341 adjacent to the second blade 342 is a. When a is too large, the liquid flow of the impeller 30 is affected. When a is too small, resistance of the second blade 342 to the liquid is affected. For example, a range of a may be limited to 8°≤a≤15°. Therefore, a may be 8° or 15°, or any value ranging from 8° to 15°. For example, a may be 10°, 11°, 12°, etc. Therefore, the liquid flow of the impeller 30 and a pressurization efficiency can be improved, reducing the resistance of the second blade 342 to the liquid, and improving the pressurization effect of the impeller 30 on the liquid.

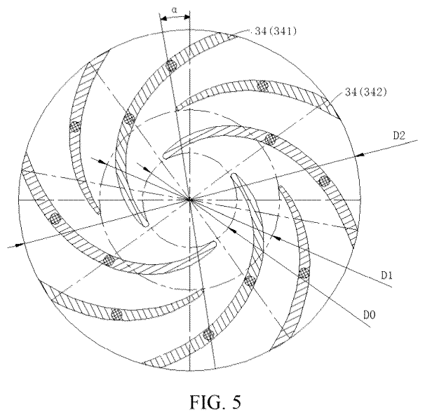

As illustrated in FIG. 5, according to some embodiments of the present disclosure, inner ends of a plurality of first blades 341 are arranged at intervals in a circumferential direction of a first hypothetical circle. The first hypothetical circle has a diameter of DO. Inner ends of a plurality of second blades 342 are arranged at intervals in a circumferential direction of a second hypothetical circle. The second hypothetical circle has a diameter of D1. The impeller 30 has a diameter of D2.

In some embodiments, when D0 is too large, pressurization effect of the impeller 30 on liquid with the small flow is affected. When D0 is too small, the liquid flow of the impeller 30 is affected. In an embodiment, 0.4D2≤D0≤0.5D2. D0 may be 0.4D2 or 0.5D2. D0 may also be any value ranging from 0.4D2 to 0.5D2. For example, D0 is 0.42D2, 0.45D2, or 0.47D2, etc. Therefore, the liquid flow of the impeller 30 and the pressurization effect of the impeller 30 on the liquid can be improved.

When D1 is too large, the resistance of the second blade 342 to the liquid is affected. When D1 is too small, pressurization effect of the impeller 30 on liquid with the large flow is affected. In an embodiment, 0.5D2≤D1≤0.6D2. D1 may be 0.5D2 or 0.6D2. D1 may also be any value ranging from 0.5D2 to 0.6D2. For example, D1 is 0.52D2, 0.55D2, or 0.58D2. Therefore, the resistance of the second blade 342 to the liquid can be reduced, increasing the liquid flow of the impeller 30 and improving the pressurization effect of the impeller 30 on the liquid.

As illustrated in FIG. 4, according to some embodiments of the present disclosure, the first blade 341 and the second blade 342 are each formed in an arc shape, which can improve a guiding effect of the blade 34 on the liquid. In addition, compared with a blade 34 without a curvature, a blade 34 with a predetermined curvature can provide buffering for the liquid, realizing step-by-step pressurization of the liquid by the blade 34. In this way, stability of the pressurization of the liquid by the impeller 30 and structural strength of the blade 34 are improved, enabling the blade 34 to withstand a higher rotational speed to improve the pressurization effect of the impeller 30 on the liquid.

As illustrated in FIG. 5, in some examples, the first blade 341 and the second blade 342 have different curvatures, in such a manner that the first blade 341 and the second blade 342 can have different guiding effects on the liquid. Therefore, the first blade 341 and the second blade 342 cooperate with each other, which can improve the stability of pressurization of the liquid by the impeller 30, preventing the water pressure from sharply decreasing with an increase of the flow.

As illustrated in FIG. 3 and FIG. 4, according to some embodiments of the present disclosure, the blade 34 has a first protrusion 343 protruding towards the second cover plate 32. The second cover plate 32 has a blade groove 321 engaged with the blade 34. A bottom wall of the blade groove 321 has a first slot 322. The blade 34 can be inserted into the blade groove 321 to fix the blade 34 between the first cover plate 31 and the second cover plate 32. In addition, the first protrusion 343 at the blade 34 can be inserted into the first slot 322 to further fix the blade 34 between the first cover plate 31 and the second cover plate 32. In this way, stability of the blade 34 can be enhanced, preventing the blade 34 from being disengaged from the impeller 30 during high-speed rotation. Therefore, operation stability of the impeller 30 can be improved. As described above, the first slot 322 is a slot for receiving the first protrusion 343, and can also be referred to as a “first protrusion-receiving slot.”

In some examples, the blade 34 and the first cover plate 31 are formed in one piece, and are processed by using a mold opening process, which can help reduce a quantity of parts of the impeller 30. In addition, the impeller 30 can be assembled as long as the first cover plate 31 is engaged with the second cover plate 32, which is convenient for operation. The second cover plate 32 is a one piece member, and is processed by using the mold opening process, which is convenient for processing. In addition, the second cover plate 32 has high structural strength, to enable the impeller 30 to withstand a higher rotational speed, further improving the pressurization effect of the impeller 30 on the liquid.

In some examples, the first protrusion 343 is connected to the second cover plate 32 through thermoplastic process. The first slot 322 may be a through hole for easy insertion of the first protrusion 343. The operator can melt a rear end of the first protrusion 343 by a hot melt gun or a welding gun. When the first protrusion 343 is re-cooled and formed, the first protrusion 343 and the first slot 322 can be melted into a whole, which can improve fixation and sealing between the first cover plate 31 and the second cover plate 32, preventing the liquid in the impeller 30 from leaking from a non-opening region to affect the pressurization effect of the impeller 30.

As illustrated in FIG. 3, in some examples, the second cover plate 32 has a connection part 323 at a center of the second cover plate 32. At least part of the connection part 323 protrudes from the second cover plate 32 towards a side of the first cover plate 31 (a front side illustrated in FIG. 3), enabling a part of the connection part 323 to extend into the center of the first cover plate 31. The part of the connection part 323 extending into the center of the first cover plate 31 can cooperate with an inner circumferential surface of the first cover plate 31 to define the impeller inlet 301 therebetween. An outer surface of the connection part 323 is a smooth arc-shaped surface to facilitate entry of the liquid into the impeller 30.

In some embodiments, a drive shaft 21 may pass through a center of the impeller 30. By arranging the connection part 323, the connection part 323 may be engaged with the drive shaft 21 to facilitate driving the impeller 30. In addition, the liquid can be prevented from directly passing through the impeller 30 along an edge of the drive shaft 21, improving the liquid flow of the impeller 30 and the pressurization effect of the impeller 30 on the liquid.

As illustrated in FIG. 3, in some examples, an outer side of the connection part 323 has a plurality of balancing holes 3232 to maintain a constant low pressure in a rear side chamber of the impeller 30. In this way, the liquid can stably flow into the impeller 30 from the impeller inlet 301, reducing a liquid flow loss in the impeller 30, improving a flow efficiency of the liquid and anti-cavitation performance of the impeller 30.

In some embodiments, arranging the balancing holes 3232 at different positions contributes to balancing an axial force to allow the impeller 30 to rotate stably, improving the operation stability of the impeller 30.

As illustrated in FIG. 3, in some examples, an inner side of the connection part 323 has a plurality of keyways 3231, which facilitates insertion of a connection structure such as a male key. By arranging a plurality of male keys at the drive shaft 21, a connection relationship can be established between the connection part 323 and the drive shaft 21. That is, when the drive shaft 21 rotates, the male key can drive the connection part 323 to rotate about an axis of the drive shaft 21 together. In this way, a drive member 20 can directly drive a plurality of impellers 30 to rotate by driving the drive shaft 21 to rotate, which can improve a transmission efficiency and thus improve the pressurization efficiency.

In some examples, an inner end of a side of the first blade 341 close to the second cover plate abuts against the connection part 323 to avoid forming a large gap between the first blade 341 and the second cover plate which affects the pressurization effect. The liquid can directly flow along the first blade 341 after passing through the impeller inlet 301, which can improve the pressurization effect of the impeller 30 on the liquid, improving the user experience.

In some examples, the inner circumferential surface of the first cover plate 31 is a convex arc-shaped surface. An outer circumferential surface of the connection part 323 is a concave arc-shaped surface. Therefore, a flow path of the liquid is expanded, providing a satisfactory guiding on flow of the liquid and reducing flow resistance of the liquid. The inner circumferential surface of the first cover plate 31 and the outer circumferential surface of the connection part 323 cooperate with each other to jointly define the impeller inlet 301, which can improve the liquid flow of the impeller 30, improving the pressurization effect of the impeller 30 on the liquid.

As illustrated in FIG. 1 to FIG. 7, a pressurization device is provided according to the embodiment of the present disclosure. The pressurization device 100 includes the impeller 30. By adopting the impeller 30, the liquid in the impeller 30 can be accelerated outflow from the impeller outlet 302 under the action of the centrifugal force to realize the pressurization on the pressurization device 100. In addition, a flow-head curve of the pressurization device 100 can be relatively flat, and the water pressure can be decreased gradually with the increase of the flow. Therefore, the efficiency of the entire machine can be effectively improved, enhancing the user experience.

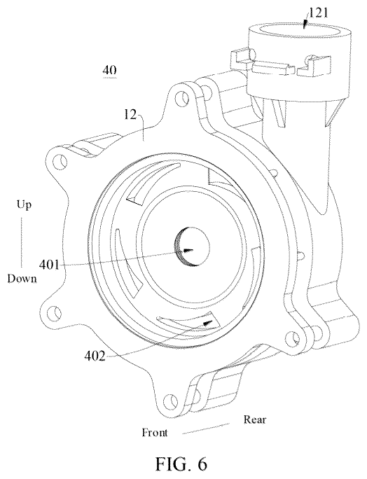

As illustrated in FIG. 1, FIG. 3, and FIG. 6, according to some embodiments of the present disclosure, the pressurization device 100 includes a housing 10, a plurality of impellers 30, a water guide member 40, and a drive member 20. The housing 10 has a water inlet 111 and a water outlet 121. The plurality of impellers 30 are disposed between the water inlet 111 and the water outlet 121. The liquid can pass through the water inlet 111, the plurality of impellers 30, and the water outlet 121 to flow through the pressurization device 100 to achieve pressurization of the pressurization device 100 on the liquid. The plurality of impellers 30 are arranged at intervals in an axial direction of the plurality of impellers 30, which can improve a pressurization effect of the pressurization device 100 on the liquid.

The water guide member 40 is disposed between two adjacent impellers 30, facilitating redirection of the liquid flow by the water guide member 40. For example, in a direction of liquid flow in the pressurization device 100, i.e., from front to back, the water guide member 40 can guide the liquid from an outlet of a front impeller 30 of two adjacent impellers 30 to an inlet of a rear impeller 30 of the two adjacent impellers 30. Therefore, the plurality of impellers 30 can cooperate with each other to achieve multiple-stage pressurization on the liquid, improving the pressurization effect of the pressurization device 100.

The drive member 20 is disposed in the housing 10. In addition, the drive member 20 can be engaged with the plurality of impellers 30 to drive the plurality of impellers 30 to rotate together, improving the transmission efficiency and further improving a transmission effect.

In some examples, the drive member 20 has a drive shaft 21. The drive member 20 is connected to an end of the drive shaft 21 to drive the drive shaft 21 to rotate. In addition, the drive shaft 21 can have the connection structure such as the male key to be connected to the impeller 30, enabling the drive shaft 21 to drive the plurality of impellers 30 to rotate about the axis of the drive shaft 21 together.

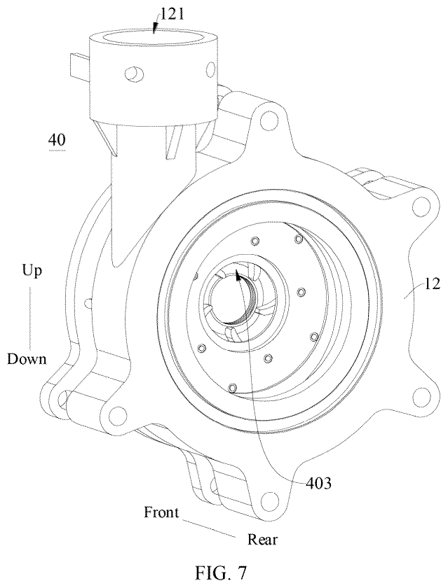

As illustrated in FIG. 6 and FIG. 7, in some examples, a center of the water guide member 40 has a through hole 401 through which the drive shaft 21 may pass, to allow the water guide member 40 to be mounted to the drive shaft 21.

In some examples, the liquid may be water. Therefore, the pressurization device 100 may be used in a gas water heater or a water pump.

As illustrated in FIG. 1 to FIG. 7, the gas water heater according to the embodiment of the present disclosure includes the pressurization device 100. By adopting the pressurization device 100, the gas water heater is pressurized. In addition, a flow-head curve of the gas water heater can be relatively flat, and the water pressure can decrease gradually with the increase of the flow. Therefore, the efficiency of the entire machine can be effectively improved, enhancing the user experience.

According to some embodiments of the present disclosure, the axis of the impeller 30 is perpendicular to a center line of the water inlet 111. For example, the center line of the water inlet 111 extends in an up-down direction. The axis of the impeller 30 extends in a front-rear direction. The plurality of impellers 30 are engaged with each other to enable water to pass through the impeller 30 in the front-rear direction, which can reduce a load of the impeller 30, improving a pressurization effect of the impeller 30 on water, and also prolonging a service life of the impeller 30. In addition, through this arrangement form, mounting and use of the pressurization device 100 in the gas water heater can be facilitated while ensuring the pressurization effect, and engagement between the water inlet 111 and an inlet of the gas water heater can be facilitated. In addition, a compact structure of the pressurization device 100 facilitates compatibility with gas water heaters of various sizes.

As illustrated in FIG. 1, according to some embodiments of the present disclosure, the water inlet 111 is located at a lower side of the water outlet 121. In addition, the center line of the water inlet 111 is parallel to a center line of the water outlet 121. For example, the center line of the water inlet 111 and the center line of the water outlet 121 extend in the up-down direction, respectively, in such a manner that a direction of water entering the pressurization device 100 and a direction of water exiting the pressurization device 100 are the same.

In some embodiments, the water inlet 111 is located at lower sides of the plurality of impellers 30. The water outlet 121 is located at upper sides of the plurality of impellers 30, which facilitates the mounting and position layout of the pressurization device 100, so as to make full use of a use space in the gas water heater. In this way, a space occupied by the pressurization device 100 can be reduced, meeting design requirements of miniaturization of the gas water heater on a basis of realizing pressurization.

As illustrated in FIG. 1, according to some embodiments of the present disclosure, a first casing 11 has a water inlet channel located between the water inlet 111 and the impeller 30. A flow area of at least part of the water inlet channel gradually increases in a front-to-rear direction. Therefore, the flow area and a flow efficiency can be ensured, increasing a water inflow at the impeller inlet 301.

As illustrated in FIG. 1, in some examples, a second casing 12 has a water outlet channel located between the impeller 30 and the water outlet 121. A flow area of at least part of the water outlet channel gradually increases in an up-down direction, ensuring a flow channel efficiency. A flow efficiency of water can be improved through engagement between the water outlet channel and the water inlet channel. Therefore, a sufficient water flow volume of the pressurization device 100 can be ensured to improve the pressurization effect of the pressurization device 100.

As illustrated in FIG. 3, according to some embodiments of the present disclosure, the impeller 30 has the impeller inlet 301 and the impeller outlet 302. The impeller inlet 301 is located at the center of the impeller 30. Therefore, the water can directly enter the impeller inlet 301 after passing through the water inlet 111. The impeller outlet 302 is located at an outer circumference of the impeller 30. When the impeller 30 rotates, the water, driven by the blade 34, moves to the outer circumference of the impeller 30 under the action of the centrifugal force. In addition, the blade 34 has the predetermined curvature, which can guide the water to flow out at a high speed from the impeller outlet 302, realizing pressurization of the impeller 30 on the water.

As illustrated in FIG. 6 and FIG. 7, in some examples, the water guide member 40 has a water guide inlet 402 and a water guide outlet 403. In the radial direction of the impeller 30, the water guide inlet 402 is located at an outer side of the impeller outlet 302, in such a manner that water pressurized by the impeller 30 located at a front side of the water guide member 40 can directly enter the water guide inlet 402. The water guide outlet 403 is located at an inner side of the water guide inlet 402, in such a manner that the water guide member 40 can allow the water pressurized by the impeller 30 to flow out from an outer circumference of the water guide member 40 to a center of the water guide member 40, and can guide the water to flow out from the water guide outlet 403. The water guide member 40 can also be configured to stably pressurize the water flow. The water guide outlet 403 is positioned to be correspond to the impeller inlet 301 of the impeller 30 located at a rear side of the water guide member 40, facilitating direct flow of water exiting the water guide outlet 403 into an impeller inlet 301 of a next impeller 30, which allows for re-pressurization of the impeller 30 on the water. Therefore, the pressurization effect of the pressurization device 100 can be improved.

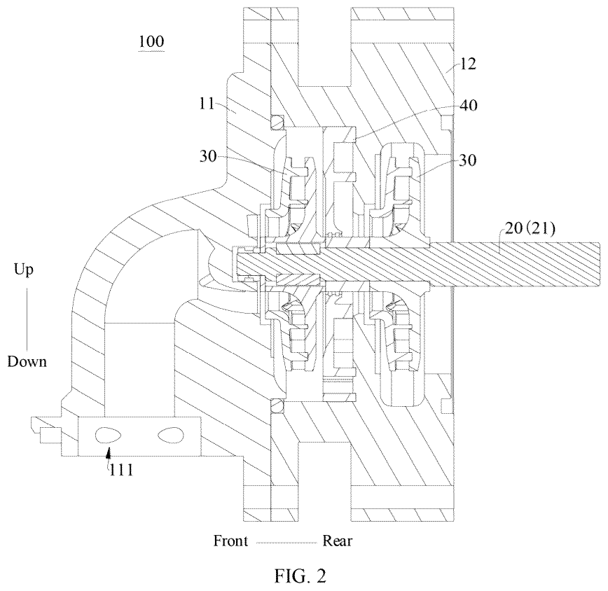

In some examples, the gas water heater is usually hung on the wall. A height and a length of the gas water heater are much larger than a thickness of the gas water heater, improving aesthetics of the product, facilitating mounting and reducing a space occupancy rate. The pressurization device 100 can be mounted in the gas water heater. The plurality of impellers 30 of the pressurization device 100 can be arranged in a length direction of the gas water heater. That is, an axial direction of the impeller 30 (a front-rear direction as illustrated in FIG. 2) is the same as the length direction of the gas water heater. Therefore, the pressurization device 100 can make full use of a space inside the gas water heater without additionally increasing a size of the gas water heater, which is conducive to meeting design requirements of miniaturization of the gas water heater. In this way, the user experience can be improved.

Other components and operations of the gas water heater according to the embodiments of the present disclosure are known to those skilled in the art, and thus details thereof will be omitted here. In the description of the present disclosure, “first feature” and “second feature” may include one or more of these features. An up-down direction, a left-right direction, and a front-rear direction are the up-down direction, the left-right direction, and the front-rear direction illustrated in the drawings.

In the description of the present disclosure, unless expressly stipulated and defined otherwise, the first feature “on” or “under” the second feature may mean that the first feature is in direct contact with the second feature, or the first and second features are in indirect contact through another feature between the first and second features. In addition, the first feature “above” the second feature means that the first feature is directly above or obliquely above the second feature, or simply means that the level of the first feature is higher than that of the second feature.

Reference throughout this specification to “an embodiment,” “some embodiments,” “an illustrative embodiment,” “an example,” “a specific example,” or “some examples” means that a particular feature, structure, material, or characteristic described in connection with the embodiment or example is included in at least one embodiment or example of the present disclosure. The appearances of the above phrases in various places throughout this specification are not necessarily referring to the same embodiment or example. Further, the particular features, structures, materials, or characteristics may be combined in any suitable manner in one or more embodiments or examples.

Although embodiments of the present disclosure have been illustrated and described, it is conceivable for those skilled in the art that various changes, modifications, replacements, and variations can be made to these embodiments without departing from the principles and spirit of the present disclosure. The scope of the invention shall be defined by the claims as appended and their equivalents.

What is claimed is:

1. An impeller comprising:
a first cover plate having an impeller inlet at a center of the first cover plate;
a second cover plate arranged opposite to the first cover plate, an impeller outlet being formed between an outer circumference of the second cover plate and an outer circumference of the first cover plate;
a first blade disposed between the first cover plate and the second cover plate; and
a second blade disposed between the first cover plate and the second cover plate and staggered with the first blade;
wherein the first blade and the second blade have different lengths.

2. The impeller according to claim 1, wherein:
in a radial direction of the impeller, the first blade has an outer end extending to an outer circumferential edge of the first cover plate and an inner end extending to an inner side of an inner circumferential edge of the first cover plate; and
the second blade has two ends disposed between the outer circumferential edge and the inner circumferential edge of the first cover plate.

3. The impeller according to claim 2, wherein:
the first blade is one of a plurality of first blades of the impeller, and the second blade is one of a plurality of second blades of the impeller;
outer ends of the first blades in the radial direction of the impeller are arranged at equal intervals in a circumferential direction of the impeller;
outer ends of the second blades in the radial direction of the impeller are arranged at equal intervals in the circumferential direction of the impeller; and
an inner end of one of the second blades in the radial direction of the impeller is offset with respect to a center of between two of the first blades that are adjacent to the one of the second blades.

4. The impeller according to claim 3, wherein the plurality of first blades include four first blades and the plurality of second blades include four second blades are provided.

5. The impeller according to claim 3, wherein the inner end of the one of the second blades is offset in a direction of rotation with respect to the center between the two of the first blades adjacent to the second blade by an offset angle that is greater than or equal to 8° and smaller than or equal to 15°.

6. The impeller according to claim 1, wherein:
the first blade is one of a plurality of first blades, and inner ends of the plurality of first blades are arranged at intervals in a circumferential direction of a first hypothetical circle;
the second blade is one of a plurality of second blades, and inner ends of the plurality of second blades are arranged at intervals in a circumferential direction of a second hypothetical circle; and
a diameter DO of the first hypothetical circle, a diameter D2 of the second hypothetical circle, and a diameter D2 of the impeller satisfy 0.4D2≤D0≤0.5D2 and 0.5D2≤D1≤0.6D2.

7. The impeller according to claim 1, wherein the first blade and the second blade are each formed in an arc shape.

8. The impeller according to claim 7, wherein the first blade and the second blade have different curvatures.

9. The impeller according to claim 1, wherein:
one blade of the first blade and the second blade includes a protrusion protruding towards the second cover plate;
the second cover plate has a blade groove, a bottom wall of the blade groove having a slot; and
the one blade is configured to be inserted into the blade groove, and the protrusion is configured to be inserted into the slot.

10. The impeller according to claim 9, wherein:
the one blade and the first cover plate are formed in one piece; and
the second cover plate is a one piece member.

11. The impeller according to claim 9, wherein the protrusion is connected to the second cover plate through thermoplastic process.

12. The impeller according to claim 1, wherein the second cover plate includes a connection part at a center of the second cover plate, at least part of the connection part protruding from a side of the second cover plate towards the first cover plate, a part of the connection part extending into the center of the first cover plate, and the impeller inlet being formed between the part of the connection part and an inner circumferential surface of the first cover plate.

13. The impeller according to claim 12, wherein an inner end of the first blade abuts against the connection part.

14. The impeller according to claim 12, wherein:
the inner circumferential surface of the first cover plate is a convex arc-shaped surface; and
an outer circumferential surface of the connection part is a concave arc-shaped surface.

15. A pressurization device comprising:
an impeller including:
a first cover plate having an impeller inlet at a center of the first cover plate;
a second cover plate arranged opposite to the first cover plate, an impeller outlet being formed between an outer circumference of the second cover plate and an outer circumference of the first cover plate;
a first blade disposed between the first cover plate and the second cover plate; and
a second blade disposed between the first cover plate and the second cover plate and staggered with the first blade;
wherein the first blade and the second blade have different lengths.

16. The pressurization device according to claim 15, wherein:
in a radial direction of the impeller, the first blade has an outer end extending to an outer circumferential edge of the first cover plate and an inner end extending to an inner side of an inner circumferential edge of the first cover plate; and
the second blade has two ends disposed between the outer circumferential edge and the inner circumferential edge of the first cover plate.

17. The pressurization device according to claim 16, wherein:
the first blade is one of a plurality of first blades of the impeller, and the second blade is one of a plurality of second blades of the impeller;
outer ends of the first blades in the radial direction of the impeller are arranged at equal intervals in a circumferential direction of the impeller;
outer ends of the second blades in the radial direction of the impeller are arranged at equal intervals in the circumferential direction of the impeller; and
an inner end of one of the second blades in the radial direction of the impeller is offset with respect to a center of between two of the first blades that are adjacent to the one of the second blades.

18. The pressurization device according to claim 15, wherein:
one blade of the first blade and the second blade includes a protrusion protruding towards the second cover plate;
the second cover plate has a blade groove, a bottom wall of the blade groove having a slot; and
the one blade is configured to be inserted into the blade groove, and the protrusion is configured to be inserted into the slot.

19. The pressurization device according to claim 15,
the impeller is one of a plurality of impellers of the pressurization device;
the pressurization device further comprising:
a housing having a water inlet and a water outlet, the plurality of impellers being disposed between the water inlet and the water outlet, and arranged at intervals in an axial direction of the plurality of impellers;
a water guide member disposed between two adjacent impellers of the plurality of impellers, the water guide member being configured to guide water at an outlet of an upstream one of the two adjacent impellers to an inlet of a downstream one of the two adjacent impellers in a direction of water flow; and
a drive member disposed at the housing and configured to be engaged with the plurality of impellers to drive the plurality of impellers to rotate.

20. A gas water heater comprising:
a pressurization device including an impeller, the impeller including:
a first cover plate having an impeller inlet at a center of the first cover plate;
a second cover plate arranged opposite to the first cover plate, an impeller outlet being formed between an outer circumference of the second cover plate and an outer circumference of the first cover plate;
a first blade disposed between the first cover plate and the second cover plate; and
a second blade disposed between the first cover plate and the second cover plate and staggered with the first blade;
wherein the first blade and the second blade have different lengths.
